(19) United States
(12) Patent Application Publication
(10) Pub. No.: US 2026/0085186 A1
(43) Pub. Date: Mar. 26, 2026

(54) Carbon-Sequestering Bioplastics

(71) Applicant: Oceans Plastic Materials Corporation, Portland, OR (US)

(72) Inventor: David Crinnion, Portland, OR (US)

(73) Assignee: Oceans Plastic Materials Corporation, Portland, OR (US)

(21) Appl. No.: 19/337,673

(22) Filed: Sep. 23, 2025

Related U.S. Application Data
(60) Provisional application No. 63/698,006, filed on Sep. 23, 2024.
(60) Provisional application No. 63/698,015, filed on Sep. 23, 2024.

(51) Int. Cl. C08L 67/04; B29C 48/00; B29K 67/00; B29K 507/04; C08J 3/20

(52) U.S. Cl. CPC C08L 67/04; B29C 48/0022; B29C 48/022; C08J 3/201; B29C 2793/0027; B29C 2793/009; B29K 2067/04; B29K 2405/00; B29K 2507/04; B29K 2995/006; C08J 2367/04; C08J 2405/04; C08L 2201/06; C08L 2203/30

(57) ABSTRACT

A carbon-sequestering algal bioplastic, comprising polyhydroxyalkanoate (PHA), sodium alginate, and biochar.

### CROSS-REFERENCE TO RELATED APPLICATIONS

This application claims the benefit under 35 U.S. C. § 119(e) of the priority of U.S. Provisional Patent Application Ser. No. 63/698,015, filed Sep. 23, 2024, and U.S. Provisional Patent Application Ser. No. 63/698,006, filed Sep. 23, 2024, the entireties of which are hereby incorporated by reference for all purposes.

### BACKGROUND OF THE INVENTION

Plastics and carbon emissions are two major concerns in current climate action. Among the solutions being investigated are bioplastics, which utilize naturally-occurring, abundant materials as an alternative to petroleum products. Biodegradable bioplastics are particularly desirable, but many ‘compostable’ plastics require temperatures that can only be achieved with industrial scale processes, while readily degradable materials may be susceptible to dissolving in water.

Biochar, a product of the pyrolysis of biomass, has been identified as a promising means of carbon sequestration. Incorporation of biochar into conventional plastics has also been investigated, but such plastics do not break down, and therefore cannot participate in a closed loop system. Addition of biochar can also result in compromised plasticity and/or a black color that interferes with recycling center processing.

New bioplastic formulations are desirable that incorporate biochar and/or are home compostable, while remaining robust and capable of delivering desired structural properties across a range of applications.

### SUMMARY OF THE INVENTION

The present disclosure provides systems, apparatus, and methods relating to bioplastics. In some examples, a bioplastic may include polyhydroxyalkanoate (PHA), sodium alginate, and biochar. In some examples, a bioplastic may consist of PHA, sodium alginate, and biochar.

In some examples, a method of manufacturing a bioplastic may include heating a polymer and subsequently adding a carbon-storing material to the polymer. The method may further include mixing and heating the combination of polymer and carbon-storing material, and subsequently adding a biomass material to the polymer. The method may further include mixing and heating the combination of polymer, carbon-storing material, and biomass material to form a bioplastic, and extruding the bioplastic.

Features, functions, and advantages may be achieved independently in various examples of the present disclosure, or may be combined in yet other examples, further details of which can be seen with reference to the following description and drawings.

### BRIEF DESCRIPTION OF DRAWINGS

FIG. 1 is a flow chart depicting steps of an illustrative method for manufacturing bioplastics according to the present teachings.

FIG. 2 is schematic diagram of an illustrative system for manufacturing bioplastics according to the method of FIG. 1.

### DETAILED DESCRIPTION OF THE INVENTION

Various aspects and examples of bioplastic materials, as well as related compositions and/or methods of manufacture, are described below and illustrated in the associated drawings. Unless otherwise specified, a material in accordance with the present teachings, and/or its various components may, but are not required to, contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed examples. The following description of various examples is merely illustrative in nature and is in no way intended to limit the disclosure, its application, or uses. Additionally, the advantages provided by the examples described below are illustrative in nature and not all examples provide the same advantages or the same degree of advantages.

This Detailed Description includes the following sections, which follow immediately below: (1) Definitions; (2) Overview; (3) Examples, Components, and Alternatives; (4) Illustrative Combinations and Additional Examples; (5) Advantages, Features, and Benefits; and (6) Conclusion. The Examples, Components, and Alternatives section is further divided into subsections A and B, each of which is labeled accordingly.

### Definitions

The following definitions apply herein, unless otherwise indicated. Additionally, as used herein, like numerals refer to like parts.

“Substantially” means to be predominantly conforming to the particular dimension, range, shape, concept, or other aspect modified by the term, such that a feature or component need not conform exactly, so long as it is suitable for its intended purpose or function. For example, a “substantially cylindrical” object means that the object resembles a cylinder, but may have one or more deviations from a true cylinder.

“Approximately” as used herein when referring to a measurable value such as a parameter, an amount, a temporal duration, and the like, is meant to encompass variations of +/−10% or less, preferably +/−5% or less, more preferably +/−1% or less, and still more preferably +/−0.1% or less of the specified value, insofar as such variations are appropriate to perform in the disclosure. It is to be understood that the value to which the modifier “approximately”refers is itself also specifically, and preferably, disclosed.

“Home compostable” as used herein may be understood to mean exhibiting full decomposition without specialized composting facilities or environments within at least two years. A home compostable material may biodegrade in naturally occurring environments or low heat artificial composting environments such as those produced by ‘lasagna method’, sheet, or no-turn composting approaches.

“Carbon negative” as used herein may be understood to mean a process or material that not only prevents the release of carbon dioxide (CO₂) into the atmosphere, but contributes to lowering of CO₂ emissions.

“Biochar” as used herein may be understood to mean a material or substance produced by heating a naturally occurring material in an oxygen-deprived environment in a process referred to as pyrolysis or carbonization. A high percentage of the heated material may be converted to carbon. Accordingly, biochar may also be referred to as biocarbon or bio-derived carbon.

### Overview

In general, a bioplastic as described herein may be a thermoplastic manufactured from a blend of constituents, components, or ingredients including at least a biomass material, a carbon-storing material, and a polymer. The polymer may be selected to achieve substantial cross-linking with the biomass material, carbon-storing material, and/or with other constituents of the bioplastic. Any polymer or polymers suitable for combination with a selected biomass material and/or carbon-storing material may be used.

For example, the polymer may be one of polycaprolactone (PCL), polybutylene adipate terephthalate (PBAT), or polyhydroxyalkanoate (PHA); and/or may be some combination thereof. PCL may combine well with biomass materials and is easily biodegradable, but has a relatively low melting point of 70 degrees Celsius (° C.) which may limit applications of the material. PBAT may be suitable for a wider range of applications with a melting point of 127° C., but may be more expensive and slower to biodegrade. PHA may be low cost, and sustainably manufacturable through fermentation of renewable materials.

The biomass material may be derived from any suitable biomass source or sources, which may be processed into any suitable form according to any suitable method. For example, the biomass material may be sodium alginate derived from brown algae by dehydration. For another example, the biomass material may be chitosan derived from deacetylation of chitin from crustaceans. Illustrative biomass sources include algae, rice, crustaceans, fungi, hemp, and seaweed. A powder format may be preferable for effective mixing with a melted polymer.

The carbon-storing material may include one or more materials storing carbon as a result of natural or artificial carbon capture. For example, the constituents may include biochar, or mineralized carbon as bicarbonate or carbonate. In some embodiments, the biomass of the bioplastic may be a carbon-storing material. Preferably, the carbon-storing material may be non-biodegradable or resistant to degradation at naturally occurring temperatures.

The bioplastic may further include one more constituents selected to achieve a desired material performance, facilitate manufacture, and/or reduce material costs. Such constituents may be selected to participate in some cross-linking with the polymer. Such constituents may additionally or alternatively be selected to be derived from renewable and/or biomass sources, for positive impact on soil health after composting, and/or to decompose into desirable and/or non-harmful materials. For example, the constituents may include glycerin and/or cellulose. Glycerin may act as a lubricant for extrusion processes and/or increase viscoelasticity of the thermoplastic. Cellulose may provide readily degradable inexpensive bulk from a renewable source.

Preferably, the bioplastic may consist of environmentally benign constituents that either are non-biodegradable or do not release undesirable compounds on decomposition. The bioplastic may be home compostable and/or exhibit full, e.g., 100%, decomposition without relying on specialized composting facilities or environments. For example, a target duration for full decomposition may be two years or less.

Incorporation of a carbon-storing material may allow the bioplastic to sequester more carbon than is used to manufacture the material. The bioplastic material may fertilize surrounding soil after decomposition. For the depicted example, phosphorous from the alginate and nitrogen from the biochar may act as fertilizers. Additionally, the biochar may benefit the soil by providing a porous substrate conducive to the growth of beneficial bacteria and fungi.

### Examples, Components, and Alternatives

The following sections describe selected aspects of exemplary bioplastic materials as well as related systems and/or methods. The examples in these sections are intended for illustration and should not be interpreted as limiting the entire scope of the present disclosure. Each section may include one or more distinct examples, and/or contextual or related information, function, and/or structure.

### Illustrative Carbon-Sequestering Bioplastic

This section describes an illustrative algal bioplastic. The described material is an example of a carbon-sequestering bioplastic as described above. In some examples, the algal bioplastic may be manufactured according to the method described in Example D, below. The resulting material may be produced as pellets for later processing. Alternatively, the bioplastic may be manufactured in a form appropriate for agricultural, industrial, and/or consumer use without additional processing, as discussed further below.

In the present example, the bioplastic consists of approximately 30% biochar, 20% sodium alginate, and 50% PHA by weight.

In the present example of a bioplastic as described above, the biomass material is derived from algae. For example, by dehydrating brown algae, sodium alginate may be obtained. Sodium alginate biocomposites may have desirable mechanical properties, such as a tensile strength of between 18 to 85 MPa. Sodium alginate is a heterocyclic compound with a carboxyl functional group. In the presence of a cross-linking agent, e.g., a polymerizing agent, sodium alginate molecules may be linked to form chains.

In the present example of a bioplastic as described above, the polymer is PHA. The polymer may be any combination of monomers in the polyhydroxyalkanoate family of polyesters. Preferably, the PHA may be a thermoplastic with a melting point in a range of approximately 50 to 200 degrees Celsius (° C.), or in a range of approximately 100 to 150° C.

PHA may be produced by culturing micro-organisms to synthesize intracellular granules from a carbon source. For example, fermentation of carbohydrates such as glucose and sucrose or of oil or glycerol. In some examples, a fermentatively produced poly-beta-hydroxybutyrate [poly(3-hydroxybutyrate), P(3HB)] consisting of 1000 to 30000 hydroxy fatty acid monomers may be used. Preferably, the PHA of the present example may be produced from a waste biomass source of carbon. For instance, malt waste, biodiesel byproduct glycerin, and/or waste water may be used.

In the present example of a bioplastic as described above, the carbon-sequestering material is biochar. The bioplastic may include any appropriate biochar product or blend of biochar materials. The biochar(s) may be produced by any effective process, from any biomass, bio feedstock, or byproduct of another process. However, some biochar materials may combine more effectively with a selected polymer or blend of polymers, to provide desired material properties to the bioplastic.

In the present example, biochars consisting solely of carbon and inorganic ash, with low levels of un-combusted or undecomposed organic matter, and/or with low levels other contaminants, may combine more effectively. Biochars having a high percentage of carbon with low levels of ash, organic matter, and other contaminants may combine more effectively. Preferably, a biochar having at least 80%, at least 90%, or at least 95% carbon may be used. A preferred biochar product may be TruBlack™ bioderived carbon from BioRegion Technology.

The ratio of the presently described embodiment of a bioplastic may provide desirable tensile strength, ductility, and flow when heated while incorporating a significant proportion of renewable biomass material and carbon-sequestering biochar. In general, a ratio of constituents may be selected according to desired properties of the bioplastic.

In some examples, the bioplastic may include PCL and/or PBAT instead of some or all of the PHA.

The sodium alginate and the biochar together may comprise no more than approximately 50% of the bioplastic in order to maintain desired levels of cross-linking. That is, the bioplastic may comprise at least approximately 50% polymer material. A bioplastic comprising less than approximately 50% polymer may be significantly brittle and difficult to form, whether by injection molding or other forming processes.

The biochar may comprise no more than approximately 45% of the bioplastic to maintain acceptable ductility. A bioplastic comprising more than approximately 45% biochar may be sufficiently brittle to crumble when handled.

In some examples, the bioplastic may include as much sodium alginate and/or biochar as maintains desired crosslinking with the PHA and/or other included polymer(s). A preferred ratio may be approximately 1 kilogram (kg) combined of biomass material and carbon sequestering material for every 1 kg of bioplastic produced.

In some examples, the bioplastic may include sufficient biochar to be carbon negative. A bioplastic with a base polymer of PBAT may include at least 43.3% biochar, a bioplastic with a base polymer of PCL may include at least 15% biochar, or a bioplastic with a base polymer of PHA may include at least 1.7% biochar. For instance, the bioplastic may comprise approximately (a) 45% biochar, 5% sodium alginate, and 50% PBAT; (b) 15% biochar, 35% sodium alginate, and 50% PLC; (c) 2% biochar, 48% sodium alginate, and 50% PHA.

In some examples, the bioplastic may include one or more additional constituents selected to achieve a desired change in one or more material properties of the bioplastic. For instance, the bioplastic may comprise between approximately 1% and 25% glycerin, to increase viscoelasticity of the bioplastic.

The bioplastic of the present example, as well as other bioplastics described herein, may be used in a variety of applications and industries, including but not limited to the following examples.

A bioplastic as described herein may be food safe, and suitable for use in food service and/or packaging applications. For example, the material may be used as a replacement for conventional plastics in single-use serving containers and/or utensils. Such products may consist of the bioplastic, may include components of bioplastic, and/or may include a covering of bioplastic. For instance, the bioplastic may form a water barrier on paper products such as cups.

An illustrative application may include adhesive films. For instance, a bioplastic may be used on produce stickers. The malleability of PCL may be particularly suited to a film application, and the material may readily degrade in the home composting environment where produce stickers frequently end up.

Another illustrative application may include apparel. For instance, the soles of footwear may comprise a bioplastic. The environmental effects of particulate released into the environment as shoes are worn down may be reduced or eliminated by decomposition of the bioplastic into inert or environmentally benign byproducts.

Another illustrative application may include agricultural and/or garden equipment. For instance, row covers, weed barrier fabrics, and light-deprivation tarps comprising a bioplastic may be left in place to decompose and/or composted with plant waste. In some examples, the biochar of the bioplastic may improve soil or compost quality.

### B. Illustrative Method of Manufacturing a Bioplastic

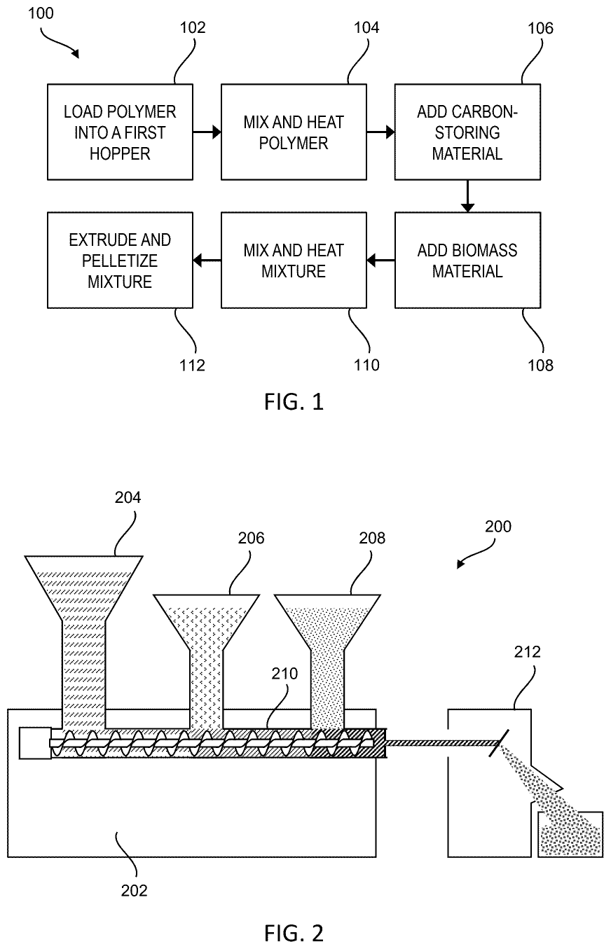

This section describes steps of an illustrative method for manufacturing a carbon-sequestering bioplastic; see FIG. 1. Aspects of materials, constituents, or techniques described above may be utilized in the method steps described below. Where appropriate, reference may be made to components and systems that may be used in carrying out each step. These references are for illustration, and are not intended to limit the possible ways of carrying out any particular step of the method.

FIG. 1 is a flowchart illustrating steps performed in an illustrative method 100, and may not recite the complete process or all steps of the method. Although various steps of method 100 are described below and depicted in FIG. 1, the steps need not necessarily all be performed, and in some cases may be performed simultaneously or in a different order than the order shown.

Method 100 is similar to methods used by many plastic manufacturers to produce thermoplastic pellets. However, testing has indicated that simply mixing the constituents of the bioplastic produces a substandard material, or other negative outcome. The method as laid out below may facilitate effective mixing and avoid damage to heat sensitive constituents.

The method includes step 102 of loading a polymer into a first hopper. The polymer may be loaded in pellet form, or other raw material form. The polymer may include PCL, PBAT, and/or PHA as described above. The hopper may be part of a manufacturing system or apparatus such as system 200, depicted in FIG. 2.

System 200 includes a twin screw extruder 202 that has three side hoppers 204, 206, 208. Each raw material may be loaded into one of the hoppers, which may feed that material into a barrel 210 of the extruder. Extruder 202 may both mix and heat the introduced raw materials.

A first of the side hoppers 204 is disposed proximate upstream end of the extruder. A pelletizer 212 may be disposed at a downstream end of extruder 202. As a compounded material is pushed out of holes in the extruder, the pelletizer may cut the material into uniformly sized pellets.

Second side hopper 206 and third side hopper 208 may be spaced along the extruder between first side hopper 204 and pelletizer 212. The second side hopper may be positioned a first distance from the first hopper, the first distance being selected to allow time for a desired degree of melting and mixing. The third hopper may be positioned a second distance from the downstream end of the extruder. The second distance may be selected to allow sufficient mixing of a material loaded through third hopper 208, while limiting and/or minimizing an amount of time for which the material loaded through the third hopper is heated by extruder 202.

In some examples system 202 may include additional mechanisms and/or apparatus for process of the bioplastic or incorporation of other materials. For instance, a drip tube may be used to add glycerin or other additional ingredients.

Returning to FIG. 1, at step 102, the polymer may be loaded through first hopper 204.

At step 104, the method includes mixing and heating the polymer. Mixing and heating may include melting the polymer, and stirring and/or homogenizing the polymer during and/or subsequent to melting. One or more polymers may be combined as part of these steps. In some examples one or more additional ingredients may be loaded into the hopper with the polymer and/or mixed into the polymer as the polymer is heated and/or as the heated polymer is mixed.

Step 106 of method 100 includes adding a carbon-storing material to the heated polymer. The carbon-storing material may be a form of biochar. Step 108 includes adding a biomass material to the heated polymer. The biomass material may include one or more of sodium alginate, chitosan, rice flour, agar, kelp powder, and hemp powder.

The carbon-storing material and biomass material may be added through a second hopper and third hoper, or any appropriate means. The biomass material and optional carbon-storing material may be added to the polymer subsequent to a sufficient degree of heating and/or melting of the polymer. In the present example, the carbon-storing material and biomass material may be added separately, one after the other. Alternatively the biomass material and carbon-storing material may be mixed together prior to addition to the polymer.

Mixing the polymer and biomass material together in one hopper and loading both the materials into the barrel at the same time may produce a substandard material, or other negative outcome. For example, the compounded material may burn, clog the extruder, or may simply not mix. Loading the polymer into the extruder barrel first, and then heating the polymer before adding further ingredients may allow the polymer to accept the biomass material and/or carbon-storing material.

At step 110, method 100 further includes mixing and heating the mixture of the polymer, the biomass material, and the carbon-storing material. This step may optionally be performed after each separate addition of material. In some examples, the method may further include addition of other ingredients such as glycerin or cellulose, either in a separate step or as a mixture with the biomass material and/or the carbon-storing material.

Preferably, any portion of step 110 performed subsequent to step 108 may be limited in duration and/or in level of heating. Excessive heating of the biomass material may be detrimental.

At least after step 110 the mixture of constituent materials may undergo cross-linking and/or other chemical changes to form a bioplastic compound. At step 112, the method includes extruding the bioplastic compound and pelletizing, or cutting the extruded material into pellets. Extrusion may be performed as part of the mixing and heating process, for instance in the barrel of an extruder. In some examples, the compound may be prepared separately prior to processing by an extruder. The extruded compound may be cut into pellets and/or otherwise subdivided and/or prepared for storage and/or transportation.

### Illustrative Combinations and Additional Examples

This section describes additional aspects and features of bioplastic materials and related methods of manufacture, presented without limitation as a series of paragraphs, some or all of which may be alphanumerically designated for clarity and efficiency. Each of these paragraphs can be combined with one or more other paragraphs, and/or with disclosure from elsewhere in this application, including the materials incorporated by reference in the Cross-References, in any suitable manner. Some of the paragraphs below expressly refer to and further limit other paragraphs, providing without limitation examples of some of the suitable combinations.
A0. A bioplastic, comprising:
a polymer, and
a biomass material, and
a carbon-storing material.
A1. The bioplastic of A0, wherein the polymer comprises no more than approximately (a) 60% or (b) 50% of the bioplastic.
A2. The bioplastic of A0 or A1, wherein the biomass material comprises at least (a) 60% or (b) 50% of the bioplastic.
A3. The bioplastic of any of A0-A2, wherein the polymer is one of PCL, PBAT, or PHA.
A4. The bioplastic of any of A0-A3, wherein the biomass material is one of sodium alginate, chitosan, rice flour, agar, kelp powder, or hemp powder.
A5. The bioplastic of A4, wherein the biomass material is sodium alginate.
A6. The bioplastic of any of A0-5, wherein the bioplastic is home compostable.
A7. The bioplastic of any of A0-A6, wherein the bioplastic is compostable at temperatures below 32 degrees Celsius (° C.).
A8. The bioplastic of A7, wherein the bioplastic is compostable at approximately 25° C.
A9. The bioplastic of A7 or A8, wherein the bioplastic fully degrades in no more than (1) year, (b) 6 months, (c) 90 days, or (d) 80 days when composted at less than 32° C.
A10. The bioplastic of any of A7-A9, wherein the bioplastic fully degrades in no more than 90 days when composted at approximately 25° C.
A11. The bioplastic of any of A7-A10, wherein a carbon dioxide content of the bioplastic has a half-life of no more than (a) 1 year, (b) 6 months, (c) 60 days, or (d) 40 days when composted at less than 32° C.
A12. The bioplastic of any of A7-A11, wherein a carbon dioxide content of the bioplastic has a half-life of no more than 50 days when composted at approximately 25° C.
A13. The bioplastic of any of A0-A12, wherein the carbon-storing material is biochar.
A14. The bioplastic of A13, wherein the biochar comprises at least (a) 20%, (b) 25%, or (c) 30% of the bioplastic.
A15. The bioplastic of any of A0-A14, wherein the biomass material comprises at least (a) 20%, (b) 25%, or (c) 30% of the bioplastic.
A16. The bioplastic of any of A13-A15, wherein all components of the bioplastic except the biochar are compostable at approximately 25° C.
A17. The bioplastic of any of A13-A16, wherein all components of the bioplastic except the biochar fully degrade in no more than (1) year, (b) 6 months, (c) 90 days, or (d) 80 days when composted at less than 32° C.
A18. The bioplastic of any of A13-A17, wherein all components of the bioplastic except the biochar fully degrade in no more than 90 days when composted at approximately 25° C.
A19. The bioplastic of any of A0-A18, wherein the bioplastic is pourable when heated to a temperature between approximately 150 and 200° C.
A20. The bioplastic of any of A0-A19, having a tensile strength of at least (a) 1, (b) 4, or (c) 5 megapascals (MPa).
A21. The bioplastic of any of A0-A20, having a tensile strength between approximately 5 and 10 MPa.
A22. The bioplastic of any of A0-A21, having a maximum elongation before break of at least 200%.
A23. The bioplastic of any of A0-A22, having a maximum elongation before break between approximately 400 and 600%.
A24. The bioplastic of any of A0-A23, wherein the bioplastic is carbon negative.
B0. An agricultural product, comprising the bioplastic of any of A0-A24.
B1. The agricultural product of B0, consisting of the bioplastic.
B2. The agricultural product of B0 or B1, wherein the product is one of (a) a tarp, (b) a row cover, (c) light deprivation sheeting.
C0. A method of manufacturing bioplastic, comprising:
heating a polymer,
adding a biomass material to the polymer,
mixing and heating the combination to form a bioplastic,
extruding the bioplastic, and cutting the extruded bioplastic into pellets.
C1. The method of C0, further including adding a carbon-storing material, prior to the extrusion step.
C2. The method of C1, wherein the carbon-storing material is mixed with the biomass material prior to addition to the polymer.
C3. The method of C1 or C2, wherein the carbon-storing material is biochar.
C4. The method of any of C0-C3, wherein the method is performed using a commercially available extrusion apparatus configured for manufacture of conventional plastics.
C5. The method of any of C0-C4, wherein the polymer is loaded into an extrusion apparatus with a first hopper, and the biomass material is added to the polymer with a second hopper, the second hopper being downstream of the first hopper on the extrusion apparatus.
C6. The method of C5 and any of C1-C3, wherein the carbon-storing material is added with the second hopper.
C7. The method of any of C0-C6, wherein the polymer is in pellet form prior to heating, and heating the polymer includes melting the polymer pellets and mixing the melted polymer.
C8. The method of C7, wherein the polymer includes pellets of more than one type of polymer.
C9. The method of any of C0-C8, wherein the biomass material is in a powder form prior to addition to the polymer.
C10. The method of C9, wherein the biomass material includes powders derived from more than one biomass source.
C11. The method of any of C0-C10, wherein mixing and heating the combination includes inducing cross-linking between the polymer and the biomass material.
C12. The method of C1 and any of C2-C11, wherein mixing and heating the combination including inducing cross-linking between the carbon-storing material and the polymer.
C13. The method of any of C0-C12, wherein the polymer is one of PCL, PBAT, or PHA.
C14. The method of any of C0-C13, wherein the biomass material is derived from one or more of algae, rice, crustaceans, fungi, hemp, and seaweed.
C15. The method of any of C0-C14, wherein the biomass material is sodium alginate.
C16. The method of any of C0-C15, wherein the biochar is TruBlack™ bioderived carbon from BioRegion Technology.
C17. The method of any of C0-C16, wherein the bioplastic manufactured is the bioplastic of any of A0-A24.
D0. A bioplastic, comprising:
polyhydroxyalkanoate (PHA);
sodium alginate; and
biochar.
D1. The bioplastic of D0, comprising at least approximately 1.7% biochar.
D2. The bioplastic of D0 or D1, comprising no more than approximately 45% biochar.
D3. The bioplastic of any of D0-D2, comprising between approximately 25% and 35% biochar.
D4. The bioplastic of any of D0-D3, comprising at least 50% PHA.
D5. The bioplastic of any of D0-D4, wherein the biochar is at least (a) 80%, (b) 90%, or (c) 95% carbon.
D6. The bioplastic of any of D0-D5, wherein the PHA is a thermoplastic.
D7. The bioplastic of any of D0-D6, wherein the PHA has a melting point between approximately 100 and 200 degrees Celsius.
D8. The bioplastic of any of D0-D7, wherein the PHA is produced from a waste biomass.
D9. The bioplastic of any of D0-D8, comprising approximately 30% biochar, 20% sodium alginate, and 50% PHA.
D10. The bioplastic of any of D0-D9, wherein the bioplastic is carbon negative.
E0. A bioplastic, consisting of:
one or more of (a) polycaprolactone (PCL), (b) polybutylene adipate terephthalate (PBAT), or (c) polyhydroxyalkanoate (PHA);
sodium alginate; and
biochar.

Advantages, Features, and Benefits The different examples of the materials and methods of manufacture described herein provide several advantages over known solutions for producing plastic materials.

Additionally, and among other benefits, illustrative examples of bioplastics described herein allow home composting. In contrast, many currently available materials such as PLA are only industrially compostable. Such materials must be transported to an industrial composting facility, of which there are still few, and which are often inaccessible to individuals or small organizations and may require local governments to support a composting program. Once at the facility, the material is placed in a high temperature compost environment that it is energy intensive to maintain.

Additionally, and among other benefits, illustrative examples of bioplastics described herein allow both carbon sequestration and maintenance of a closed loop system. Some materials have been produced which introduce biochar into conventional plastics, to provide carbon sequestration. However, the materials do not biodegrade and therefore cannot form a closed loop system. A compostable bioplastic including biochar may allow carbon sequestration, and also closing of the loop through return of the other constituents to the soil.

Additionally, and among other benefits, illustrative examples of bioplastics described herein benefit soil health. Introduction of biochar and products of the decomposition of a biomass material to soil through decomposition of a bioplastic may also benefit the soil. For example, algae and/or associated algal products such as sodium alginate are high in phosphorus, oxygen, and nitrogen, which is a natural fertilizer. Biochar is also used in farming and agricultural industries to improve soil quality. Biochar has a porous structure that is attractive to beneficial microorganisms that can help bring nutrients to the soil without releasing the sequestered carbon.

Additionally, and among other benefits, illustrative examples of bioplastics described herein allow straightforward manufacture. Established plastic manufacturing techniques and widely available manufacturing equipment may therefore be usable with limited alteration. Such manufacturability may reduce production costs, allow part-time use of existing manufacturing facilities, and/or facilitate conversion of existing manufacturing infrastructure. In many scenarios production of a highly compostable plastic or bioplastic requires new manufacturing methods and equipment which can be costly and time consuming. Bioplastics as described herein may allow for immediate expedited scaling.

Additionally, and among other benefits, illustrative examples of bioplastics described herein consist of only a few ingredients. Some embodiments may include only three ingredients. The bioplastics described herein may therefore be simpler, faster, and less expensive to manufacture than existing bioplastics, which require a plethora of raw material ingredients.

Additionally, and among other benefits, illustrative examples of bioplastics described herein have good mechanical characteristics, such that the bioplastic looks, acts, and feels like a traditional plastic.

No known material can perform these functions, particularly with low cost and widely available constituents. Thus, the illustrative examples described herein are particularly useful as replacements for conventional plastic materials in disposable or short-lived products used in connection with food and agriculture. However, not all examples described herein provide the same advantages or the same degree of advantage.

### Conclusion

The disclosure set forth above may encompass multiple distinct examples with independent utility. Although each of these has been disclosed in its preferred form(s), the specific examples thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

1. A bioplastic, comprising:
polyhydroxyalkanoate (PHA);
sodium alginate; and
biochar.

2. The bioplastic of claim 1, comprising at least approximately 1.7% biochar.

3. The bioplastic of claim 2, comprising no more than approximately 45% biochar.

4. The bioplastic of claim 3, comprising between approximately 25% and 35% biochar.

5. The bioplastic of claim 3, comprising at least 50% PHA.

6. The bioplastic of claim 5, wherein the PHA is a thermoplastic.

7. The bioplastic of claim 6, wherein the biochar comprises at least 90% carbon.

8. The bioplastic of claim 1, comprising approximately 30% biochar, 20% sodium alginate, and 50% PHA.

9. The bioplastic of claim 1, wherein the bioplastic is home compostable.

10. The bioplastic of claim 1, wherein all components of the bioplastic except the biochar are compostable at temperatures below 32 degrees Celsius (° C.).

11. The bioplastic of claim 1, wherein the bioplastic is carbon negative.

12. A bioplastic, consisting of:
one or more of (a) polycaprolactone (PCL), (b) polybutylene adipate terephthalate (PBAT), or (c) polyhydroxyalkanoate (PHA);
sodium alginate; and
biochar.

13. The bioplastic of claim 12, consisting of approximately 30% biochar, 20% sodium alginate, and 50% PHA.

14. A method of manufacturing bioplastic, comprising:
heating a polymer;
subsequently adding carbon-storing material to the polymer;
mixing and heating the combination of polymer and carbon-storing material;
subsequently adding a biomass material to the polymer;
mixing and heating the combination of polymer, carbon-storing material, and biomass material to form a bioplastic; and
extruding the bioplastic.

15. The method of claim 14, further including cutting the extruded bioplastic into pellets.

16. The method of claim 14, wherein the polymer is PHA, the biomass material is sodium alginate, and the carbon-storing material is biochar.

17. The method of claim 14, wherein the polymer is in pellet form prior to heating, and heating the polymer includes melting the polymer pellets and mixing the melted polymer.

18. The method of claim 17, wherein the biomass material is in a powder form prior to addition to the polymer.

19. The method of claim 14, wherein the method is performed using a commercially available extrusion apparatus configured for manufacture of conventional plastics.

20. The method of claim 19, wherein the polymer is loaded into the extrusion apparatus with a first hopper, and the biomass material is added to the polymer with a second hopper, the second hopper being downstream of the first hopper on the extrusion apparatus.
